(19) United States
(12) Patent Application Publication
(10) Pub. No.: US 2008/0176156 A1
(43) Pub. Date: Jul. 24, 2008

(54) COMPOSITION USED IN CHARGE TRANSPORT LAYER OF ORGANIC PHOTO CONDUCTOR

(75) Inventors: Fu-Shing Wang, Taichung (TW); Ming-Feng Hsu, Taichung (TW)

Correspondence Address: MADSON & AUSTIN, 15 WEST SOUTH TEMPLE, SUITE 900, SALT LAKE CITY, UT, 84101, US

(73) Assignee: TUBE SMITH Technology CO., LTD., Taichung (TW)

(21) Appl. No.: 11/691,937

(22) Filed: Mar. 27, 2007

(30) Foreign Application Priority Data
Jan. 23, 2007 (TW) 096102563

(51) Int. Cl. G03G 15/02

(52) U.S. Cl. 430/58.8

(57) ABSTRACT

A composition for use in a charge transport layer of an organic photo conductor is provided. The composition includes:
(a) a mixture of N,N′-Bis(3-methylphenyl)-N,N′-diphenyl-benzidine (Compound I), 4-((N,N-diphenylamino)-4′-(N-(3-methylphenyl)-N-phenylamino)-biphenyl (Compound II) and N,N,N′,N′-tetraphenylbenzidine (Compound III); and
(b) Compound IV of the formula (IV):

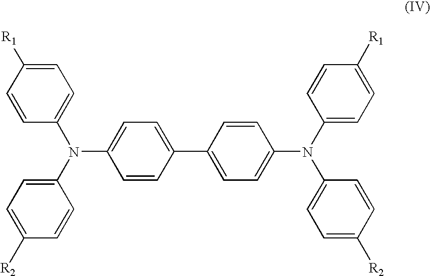

where,
R₁ and R₂ independently denote C₁-C₄-alkyl group or C₁-C₄-alkoxy group, and
wherein the weight ratio of Compound IV to combined Compound I, Compound II and Compound III is in a range from 1/5 to 5.

### FIELD OF THE INVENTION

The present invention relates to a composition having a mixture of triphenylamine dimer derivatives, and more particularly to a composition having a mixture of triphenylamine dimer derivatives for use in a charge transport layer of an organic photo conductor.

### BACKGROUND OF THE INVENTION

An organic photo conductor (OPC) is one of the most important elements in toner cartridges of electrophotographic imaging devices such as laser printers or copy machines. The organic photo conductor acts as an insulator in the dark but will be a conductor when exposed to light.

Typically, the laser printing process includes several steps such as charging, exposure, developing, fusing, erasing, etc. These steps of the laser printing process are implemented with respect to the organic photo conductor. When a desired organic photo conductor is selected, the performance (e.g. printing resolution, contrast ratio and/or printing speed) of the laser printers or copy machines may be enhanced.

Most organic photo conductors are provided in a multi-layer structure. From the interior to the exterior, the organic photo conductor includes a conductive aluminum substrate, a binding resin layer, a charge generation layer (CGL), a charge transport layer (CTL) and a protective layer. In this multi-layer structure, the materials constituting the charge generation layer and the charge transport layer are critical for determining the performance of the organic photo conductor.

Generally, the materials constituting the charge generation layer include for example titanyl phthalocyanine (TiOPc), diazo compounds, etc. The materials constituting the charge transport layer include for example triphenylamine dimer (TPD) derivates, triphenylamines, hydrazone derivatives, etc.

When a TPD derivate is used as the CTL material of the organic photo conductor, crystallization is liable to occur. As known, both the electric property of the TPD itself and the film-forming property thereof are both important properties for getting the better electric property. If crystals of TPD are deposited in a film during a drying step and uniformity of the film is lost, the electric property of the organic photo conductor is deteriorated obviously.

Therefore, there is a need of providing a composition having mixed triphenylamine dimer derivatives for preventing occurrence of crystallization while providing excellent electric properties.

### SUMMARY OF THE INVENTION

The present invention provides a mixture of triphenylamine dimer derivatives to be used in a charge transport layer of an organic photo conductor, thereby providing excellent electric properties without occurrence of crystallization.

In an aspect, the present invention relates to a mixture of triphenylamine dimer derivatives for use in a charge transport layer of an organic photo conductor. The mixture include:

Compound I of the formula (I),

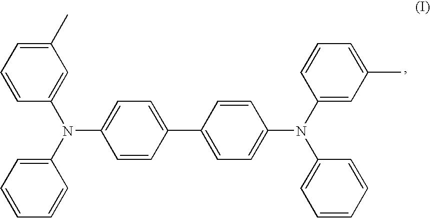

N,N′-Bis(3-methylphenyl)-N,N′-diphenyl-benzidine
   Compound II of the formula (II),

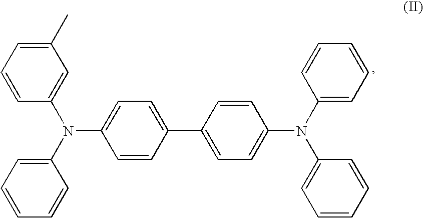

4-((N,N-diphenylamino)-4′-(N-(3-methylphenyl)-N-phenylamino)-biphenyl
   and
   Compound III of the formula (III),

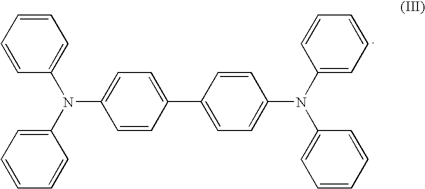

N,N,N′,N′-Tetraphenylbenzidine

In the above mixture of triphenylamine dimer derivatives, the mixture comprises 0.1 to 95 wt % of Compound I, 0.1 to 95 wt % of Compound II, and 0.1 to 95 wt % of Compound III, based on the total weight of Compounds I, II and III.

Preferably, the mixture comprises 60 to 90 wt % of Compound I, 5 to 30 wt % of Compound II, and 1 to 10 wt % of Compound III, based on the total weight of Compounds I, II and III.

By regulating the relative amount between the Compounds I, II and III, the charge transport layer will possess excellent electric properties such as reduced residual potential. Moreover, the use of the mixture of triphenylamine dimer derivatives may provide a non-crystalline thin film. When used in a charge transport layer of an organic photo conductor of an electrophotographic imaging device, the mixture of triphenylamine dimer derivatives is excellent in photoelectric properties and film-forming properties so as to increase sensitivity, printing resolution, contrast ratio and/or printing speed of the electrophotographic imaging device.

For facilitating reducing the residual potential, the mixture of triphenylamine dimer derivatives may further a Compound IV of the formula (IV):

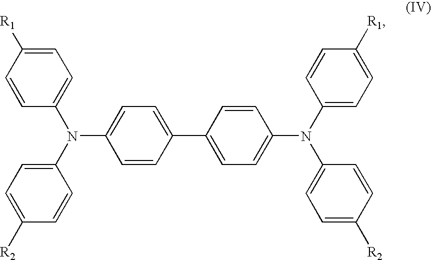

where,
R₁ and R₂ independently of one another denote C₁-C₄-alkyl group such as methyl, ethyl, propyl, iso-propyl, butyl, tert-butyl and iso-butyl; or alkoxy group such as methoxy and ethoxy.

That is, by introducing the R₁ and R₂ groups into the aromatic rings at the para-position (i.e. the fourth position) of the triphenylamine dimer, the Compound IV may reduce the residual potential of the Compounds I, II and III. If the R₁ and R₂ groups in the formula (IV) are both methyl, a Compound V of the formula (V) is obtained and the residual potential reduction is considerable.

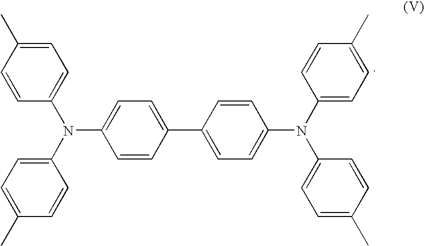

N,N,N′,N′-Tetrakis(4-methylphenyl)-benzidine

The weight ratio of Compound IV to combined Compound I, Compound II and Compound III is in a range from 1/5 to 5, more preferably from 1/4 to 4, and most preferably from 1/3 to 3. The present inventor has discovered that, as the content of the Compound IV is increased, the residual potential is gradually decreased. However, due to symmetrical structure of the Compound IV, crystallization is liable to occur when the Compound IV substitutes for the mixed triphenylamine dimers of the Compounds I, II and III.

The synthesis of the Compounds I, III, IV and V involves two steps. In a first step, phenylamines with different substituents are firstly subject to protection and then reacted with aryl halide via Ullmann reaction. The crude products are de-protected to result in amines, as is described in the following scheme (A). In a second step, in the presence of a base and copper as a catalyst, the amines obtained in the first step are reacted with diaryl halide via the Ullmann reaction, as is described in the following scheme (B).

For example, the synthesis of the Compound IV will be illustrated with reference to the following schemes:

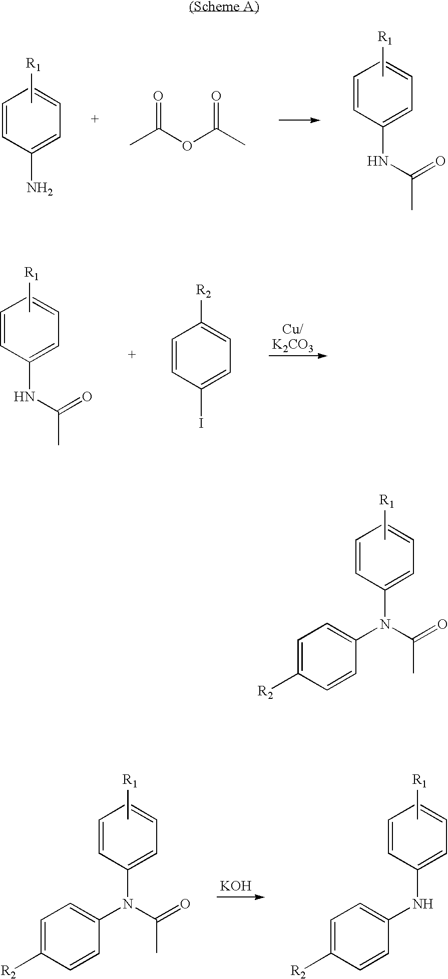

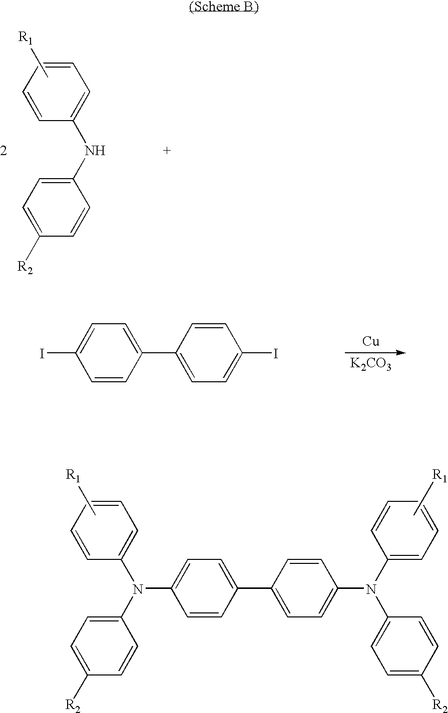

If R₁═CH₃ and R₂═H In the above schemes, the Compound I is synthesized. If R₁═R₂═H, the Compound III is synthesized. If R₁=R₂═CH₃, the Compound V is synthesized.

The synthesis of the Compound II is similar to that described above, except that the second step is replaced by the following scheme (C):

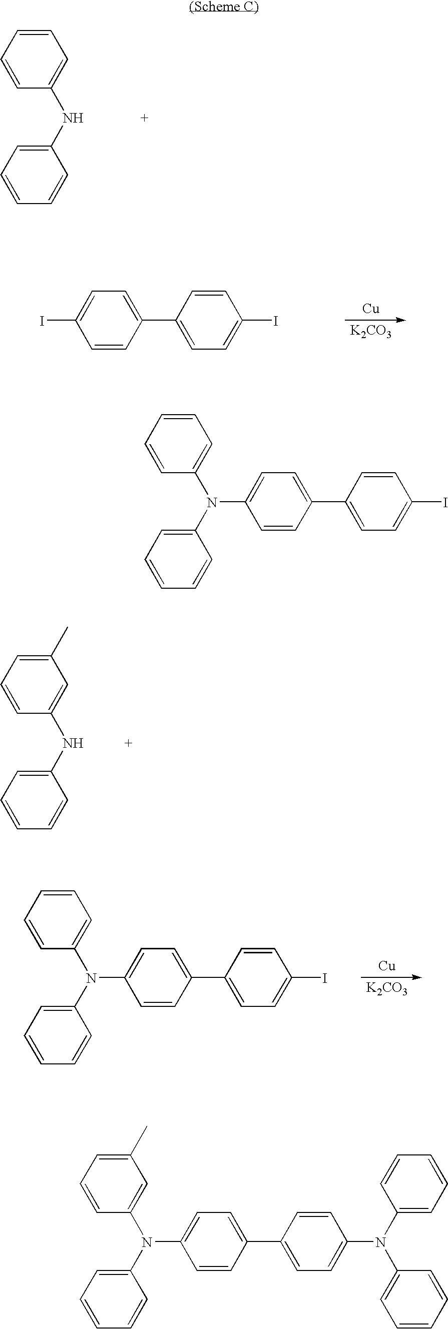

In accordance with another aspect, the present invention relates to a composition for use in a charge transport layer of an organic photo conductor. The composition comprises:
(a) a mixture of N,N′-Bis(3-methylphenyl)-N,N′-diphenyl-benzidine (Compound I), 4-((N,N-diphenylamino)-4′-(N-(3-methylphenyl)-N-phenylamino)-biphenyl (Compound II) and N,N,N′,N′-tetraphenylbenzidine (Compound III); and
(b) Compound IV of the formula (IV):

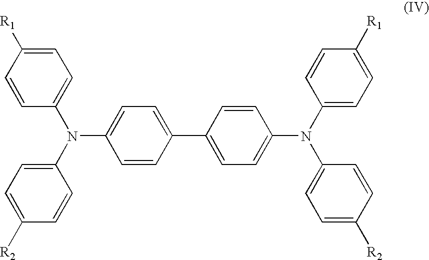

where,
R₁ and R₂ independently denote C₁-C₄-alkyl group or C₁-C₄-alkoxy group, and
wherein the weight ratio of Compound IV to combined Compound I, Compound II and Compound III is in a range from 1/5 to 5.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention is hereinafter described by way of examples, but is not intended to be restricted to these examples. In these examples, the temperature is indicated in Centigrade and all percentages are by weight unless otherwise indicated. All materials or reagents used in the following examples are commercially available from Aldrich Chemical Co. (Milwaukee Wis. USA) and Merck & Co., Inc. (New Jersey, USA) unless otherwise specified. In addition, all materials or reagents are used as received without further purification unless otherwise specified.

Synthesis of 4,4′-dimethyldiphenylamine

To a 500-ml round bottom flask, 53.5 g of p-toluidine and 200 ml of dichloromethane were added. Under nitrogen atmosphere, 66.3 g of acetic anhydride was added, and the solution was maintained at room temperature (about 25° C.) for about 2 hours. After the reaction, sodium carbonate solution was added dropwise for neutralizing the reaction solution until neutrality. The reaction solution was concentrated under reduced pressure to give 73.5 g of crude product (yield=98.65%).

The obtained crude product (73.5 g), 170 ml of o-dichlorobenzene, 82 g of potassium carbonate, 161 g of p-iodotoluene, 13 g of 18-crown-6 ether and 37.6 g of copper powder were added into a 500-ml round bottom flask. The solution was heated to reflux for 48 hours under nitrogen atmosphere. After the reaction solution was cooled to 150±5° C., the precipitates were filtered off. The filtration was concentrated under reduced pressure to give 99.55 g of crude product, which was purified by column chromatography to give 89.3 g of white solid (yield=75.7%).

The obtained white solid (89.3 g), 250 ml of ethanol and 62.7 g of KOH were added into a 500-ml round bottom flask. The solution was heated to reflux under nitrogen atmosphere, and maintained at the reflux temperature of about 85° C. for 3 hours. The reaction solution was extracted with toluene. The supernatant was concentrated under reduced pressure to give 71 g of crude product, which was purified by column chromatography to give 63.5 g of white solid (yield=86.3%).

### Preparation of Compound I

To a 500-ml round bottom flask, 81.2 g of diiodobiphenyl, 170 ml of o-dichlorobenzene, 58 g of potassium carbonate, 91.5 g of 3-methyldiphenylamine, 5.28 g of 18-crown-6 ether and 76.3 g of copper powder were added. The solution was heated to reflux under nitrogen atmosphere, and maintained at the reflux temperature for 24 hours. The reaction solution was cooled and filtered. The filtration was concentrated under reduced pressure to give 113 g of crude product, which was purified by column chromatography to give 87 g (yield=84.4%) of white solid, i.e. the Compound I of the formula (I).

### Preparation of Compound II

To a 500-ml round bottom flask, 81.2 g of diiodobiphenyl, 170 ml of o-dichlorobenzene, 58 g of potassium carbonate, 84.5 g of diphenylamine, 5.28 g of 18-crown-6 ether and 76.3 g of copper powder were added. The solution was heated to reflux under nitrogen atmosphere, and maintained at the reflux temperature for 24 hours. The reaction solution was cooled and filtered. The filtration was concentrated under reduced pressure to give 113 g of crude product. The crude product was recrystalized from ethyl acetate cooled down to 10˜5° C. for 30 minutes, and filtered to give 73 g of yellowish solid (yield=78.5%).

The obtained yellowish solid (89.2 g), 170 ml of o-dichlorobenzene, 58 g of potassium carbonate, 73.2 g of 3-methyldiphenylamine, 5.28 g of 18-crown-6 ether and 76.3 g of copper powder were added into a 500-ml round bottom flask. The solution was heated to reflux under nitrogen atmosphere, and maintained at the reflux temperature for 24 hours. The reaction solution was cooled and filtered. The filtration was concentrated under reduced pressure to give 126 g of crude product, which was purified by column chromatography to give 73 g (yield=74.4%) of white solid, i.e. the Compound II of the formula (II).

### Preparation of Compound III

To a 500-ml round bottom flask, 81.2 g of diiodobiphenyl, 170 ml of o-dichlorobenzene, 58 g of potassium carbonate, 88.5 g of diphenylamine, 5.28 g of 18-crown-6 ether and 76.3 g of copper powder were added. The solution was heated to reflux under nitrogen atmosphere, and maintained at the reflux temperature for 24 hours. The reaction solution was cooled and filtered. The filtration was concentrated under reduced pressure to give 105.6 g of crude product, which was purified by column chromatography to give 82.6 g (yield=84.6%) of white solid, i.e. the Compound III of the formula (III).

### Preparation of Compound V

To a 500-ml round bottom flask, 81.2 g of diiodobiphenyl, 170 ml of o-dichlorobenzene, 58 g of potassium carbonate, 94.7 g of 4,4′-dimethyl diphenylamine, 5.28 g of 18-crown-6 ether and 76.3 g of copper powder were added. The solution was heated to reflux under nitrogen atmosphere, and maintained at the reflux temperature for 24 hours. The reaction solution was cooled and filtered. The filtration was concentrated under reduced pressure to give 133 g of crude product, which was purified by column chromatography to give 83 g (yield=76.2%) of white solid, i.e. the Compound V of the formula (V).

### Preparation of Compositions Used in a Charge Transport Layer of an Organic Photo Conductor

Six exemplary compositions (Examples 1˜6) were prepared by mixing the triphenylamine dimer derivatives of the Compounds I, II, III and IV according to the type and amount indicated in Table 1. These exemplary compositions are suitable as charge-transporting materials of organic photo conductors. For comparison, two comparative compositions (Comparative examples 1˜2) are also prepared. As shown in Table 1, the respective compositions of Examples 1˜3 include the Compounds I, II and III. In addition to the Compounds I, II and III, the respective compositions of Examples 4˜7 include gradually increased Compound IV. The composition of Comparative example 1 contains 100% of the Compound I. The composition of Comparative example 2 contains 100% of the Compound IV.

TABLE 1
Compositions having a mixture of triphenylamine dimer derivatives

| | | Compound | Compound | Compound |
|---|---|---|---|---|
| No. | Compound I | II | III | IV |
| Example 1 | 84.0% | 12.0% | 4.0% | — |
| Example 2 | 74.0% | 24.5% | 1.5% | — |
| Example 3 | 86.0% | 13.0% | 1.0% | — |
| Example 4 | 68.0% | 9.6% | 2.4% | 20.0% |
| Example 5 | 51.0% | 7.2% | 1.8% | 40.0% |
| Example 6 | 42.5% | 6.0% | 1.5% | 50.0% |
| Example 7 | 25.95% | 3.75% | 0.3% | 70.0% |
| Comparative | 100% | — | — | — |
| example 1 | | | | |
| Comparative | — | — | — | 100% |
| example 2 | | | | |

### Preparation of Organic Photo Conductors

With stirring and heating, a polyvinyl butyral (PVB) resin is completely dissolved in tetrahydrofuran (THF) and methyl ethyl ketone (MEK), thereby resulting in a resin solution having solubility of about 5% by weight. Then, γ-TiOPC (about 2.0%) is added into the resin solution and uniformly mixed to form a coating solution for coating the charge generation layer.

Further, with stirring and heating, a polycarbonate resin (trade name: PC-Z, manufactured by Mitsubishi Gas Chemical) is completely dissolved in tetrahydrofuran (THF) and toluene, thereby resulting in a resin solution having solubility of about 12.5% by weight. Then, 12% by weight of the compositions having mixed triphenylamine dimer derivatives as prepared in Examples 1˜7 and Comparative examples 1˜2 are added into the resin solution and uniformly mixed to form a coating solution for coating the charge transport layer.

A protective layer material is obtained by mixing 50% phenolic resin and 50% ethanol.

By using a dip coating process, an aluminum substrate was successively coated with a charge generation layer having a thickness of 0.2 micrometer, a charge transport layer and a protective layer to form an organic photo conductor.

### Photoelectric Property Test of Organic Photo Conductors

The photoelectric properties of the organic photo conductors were tested under a photo-induced discharge curve (PIDC) method using a QEA-PDT2000 OPC tester. This method involved a corona discharge to apply a negative voltage (V₀) of about −700 volts onto the surface of the organic photo conductor. The charge was held for 2 seconds without light exposure to allow the surface of the organic photo conductor to reach a dark development potential (V_{ddp}), which is typically the same as V₀. A dark decay potential (V_{dd}) is defined as the difference between V₀ and V_{ddp} after these two seconds. The organic photo conductor was then exposed to a halogen lamp having a wavelength of 780 nm and an exposure density of 1.0 μJ/cm². The residual potential (Vᵣ) is defined as the surface potential after the conclusion of the illumination, and the half-decay energy density (E_{1/2}) is defined as the light density required to reduce the dark development potential to half of its value. The photoelectric properties of the organic photo conductor were evaluated based on their dark decay potential (V_{dd}), residual potential (Vᵣ) and half-decay energy density (E_{1/2}). Half exposure energy is a value indicating the photosensitivity. A lower E_{1/2} value indicates a higher photosensitivity.

Table 2 shows results of PIDC tests on the organic photo conductors whose charge transport layers are made of respective compositions of Examples 1˜7 and Comparative examples 1˜2.

TABLE 2
photoelectric properties of the organic photo conductors

| | dark development | residual | half-decay | dark decay | |
|---|---|---|---|---|---|
| | potential | potential | energy density | potential | |
| Composition | (V_{ddp}) (V₀) | (Vᵣ) | (E_{1/2}) | (V_{dd}) | crystallization |
| Example 1 | 711.47 | 31.96 | 0.097 | 15.9 | no |
| Example 2 | 723.40 | 32.73 | 0.094 | 13.5 | no |
| Example 3 | 726.09 | 36.58 | 0.097 | 10.9 | no |
| Example 4 | 700.79 | 22.90 | 0.092 | 16.01 | no |
| Example 5 | 700.49 | 21.74 | 0.096 | 15.3 | no |
| Example 6 | 707.02 | 19.77 | 0.095 | 13.5 | no |
| Example 7 | 702.19 | 9.05 | 0.098 | 11.8 | no |
| Comparative | 706.01 | 30.09 | 0.096 | 16.9 | High |
| Example 1 | | | | | crystallinity |
| Comparative | 700.49 | 5.02 | 0.093 | 6.01 | High |
| Example 2 | | | | | crystallinity |

As shown in Table 2, when the composition of Comparison Example 1 (100% Compound I) is used as the charge transport layer material, serious crystallization occurs and the film-forming property is obviously deteriorated.

By regulating the relative amount between the Compounds I, II and III, the use of the compositions of Example 1˜3 as the charge transport layer provides a non-crystalline thin film. In addition, the low E_{1/2} value indicates a better photosensitivity of the organic photo conductors produced therefrom. However, the relatively higher residual potential values need to be further reduced.

It may be seen from the results shown in Table 2 that the compositions of Examples 4˜7 have gradually decreased residual potential when the content of the Compound IV is increased. In addition, the use of the compositions of Example 4˜7 as the charge transport layer also provides a non-crystalline thin film. As a consequence, the results demonstrated that the addition of the Compound IV into the Compounds I, II and III is effective to largely reduce the residual potential. Such low residual potential values contribute to a high printing speed of the organic photo conductor.

As also shown in Table 2, when the composition of Comparison Example 2 (100% Compound IV) is used as the charge transport layer material, serious crystallization occurs and the film-forming property is obviously deteriorated.

From the above description, the composition of the present invention is capable of providing excellent electric properties (e.g. reduced residual potential) as well as good film-forming properties (e.g. non-crystalline thin film) by properly regulating the relative amount between the Compounds I, II, III and IV. When used in a charge transport layer of an organic photo conductor, the mixtures of triphenylamine dimer derivatives are excellent in photoelectric properties.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mixture of triphenylamine dimer derivatives for use in a charge transport layer of an organic photo conductor, comprising:
Compound I of the formula (I), 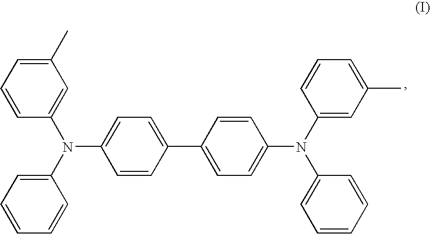
N,N′-Bis(3-methylphenyl)-N,N′-diphenyl-benzidine
Compound II of the formula (II), 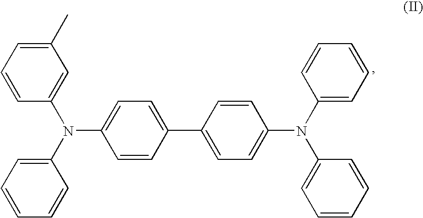
4-((N,N-diphenylamino)-4′-(N-(3-methylphenyl)-N-phenylamino)-biphenyl
and
Compound III of the formula (III), 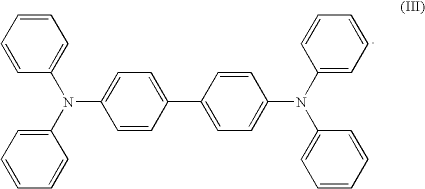
N,N,N′,N′-Tetraphenylbenzidine

2. The mixture according to claim 1, comprising 0.1 to 95 wt % of Compound I, 0.1 to 95 wt % of Compound II, and 0.1 to 95 wt % of Compound III, based on the total weight of Compounds I, II and III.

3. The mixture according to claim 1, comprising 60 to 90 wt % of Compound I, 5 to 30 wt % of Compound II, and 1 to 10 wt % of Compound III, based on the total weight of Compounds I, II and III.

4. The mixture according to claim 1, further comprising Compound IV of the formula (IV), 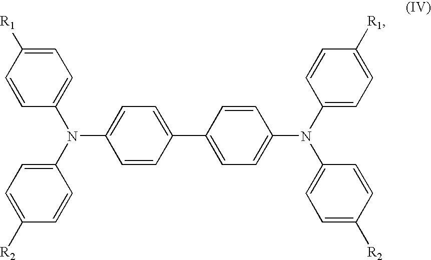
where,
R₁ and R₂ independently denote C₁-C₄-alkyl group or C₁-C₄-alkoxy group.

5. The mixture according to claim 4 wherein R₁ and R₂ independently denote methyl, ethyl, propyl, iso-propyl, butyl, tert-butyl and iso-butyl, methoxy or ethoxy.

6. The mixture according to claim 4, further comprising Compound V of the formula (V), 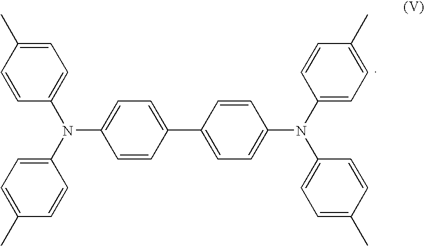
N,N,N′,N′-Tetrakis(4-methylphenyl)-benzidine

7. The mixture according to claim 4 wherein the weight ratio of Compound IV to combined Compound I, Compound II and Compound III is in a range from 1/5 to 5.

8. The mixture according to claim 4 wherein the weight ratio of Compound IV to combined Compound I, Compound II and Compound III is in a range from 1/3 to 3.

9. A composition for use in a charge transport layer of an organic photo conductor, comprising:
(a) a mixture of N,N′-Bis(3-methylphenyl)-N,N′-diphenyl-benzidine (Compound I), 4-((N,N-diphenylamino)-4′-(N-(3-methylphenyl)-N-phenylamino)-biphenyl (Compound II) and N,N,N′,N′-tetraphenylbenzidine (Compound III); and
(b) Compound IV of the formula (IV): 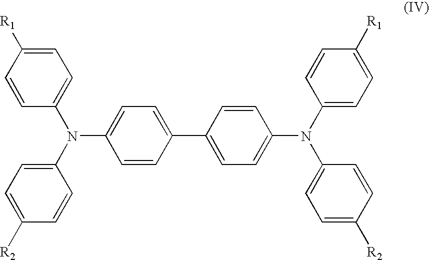
where,
R₁ and R₂ independently denote C₁-C₄-alkyl group or C₁-C₄-alkoxy group, and
wherein the weight ratio of Compound IV to combined Compound I, Compound II and Compound III is in a range from 1/5 to 5.

10. The composition according to claim 9 wherein R₁ and R₂ independently denote methyl, ethyl, propyl, iso-propyl, butyl, tert-butyl and iso-butyl, methoxy or ethoxy.

11. The composition according to claim 9 wherein R₁ is methyl and R₂ is methyl.

12. The composition according to claim 9 wherein the mixture (a) comprises 0.1 to 95 wt % of Compound I, 0.1 to 95 wt % of Compound II, and 0.1 to 95 wt % of Compound III, based on the total weight of Compound I, Compound II and Compound III.

13. The composition according to claim 9 wherein the mixture (a) comprises 60 to 90 wt % of Compound I. 5 to 30 wt % of Compound II, 1 to 10 wt % of Compound III, based on the total weight of Compound I, Compound II and Compound III.

14. The composition according to claim 9 wherein the weight ratio of Compound IV to combined Compound I, Compound II and Compound III is in a range from 1/3 to 3.

15. A charge transport layer of an organic photo conductor, comprising:
(a) a mixture of 0.1 to 95 wt % of N,N′-Bis(3-methylphenyl)-N,N′-diphenyl-benzidine (Compound I), 0.1 to 95 wt % of 4-((N,N-diphenylamino)-4′-(N-(3-methylphenyl)-N-phenylamino)-biphenyl (Compound II) and 0.1 to 95 wt % of N,N,N′,N′-tetraphenylbenzidine (Compound III), based on the total weight of Compound I, Compound II and Compound III; and
(b) Compound IV of the formula (IV): 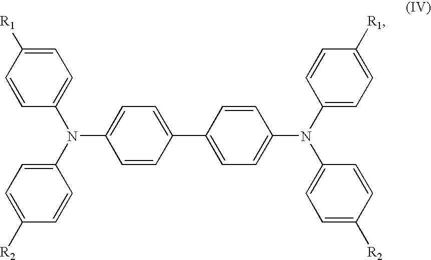
where,
R₁ and R₂ independently denote C₁-C₄-alkyl group or C₁-C₄-alkoxy group, and
wherein the weight ratio of Compound IV to combined Compound I, Compound II and Compound III is in a range from 1/5 to 5.

16. The charge transport layer according to claim 15 wherein R₁ and R₂ independently denote methyl, ethyl, propyl, iso-propyl, butyl, tert-butyl and iso-butyl, methoxy or ethoxy.

17. The charge transport layer according to claim 15 wherein R₁ is methyl and R₂ is methyl.

18. The charge transport layer according to claim 15 wherein the mixture (a) comprises 60 to 90 wt % of Compound I, 5 to 30 wt % of Compound II, and 1 to 10 wt % of Compound III, based on the total weight of Compound I, Compound II and Compound III.

19. The charge transport layer according to claim 15 wherein the weight ratio of Compound IV to combined Compound I, Compound II and Compound III is in a range from 1/3 to 3.
